(19) United States
(12) Patent Application Publication
(10) Pub. No.: US 2019/0250455 A1
(43) Pub. Date: Aug. 15, 2019

(54) DISPLAY PANEL, MANUFACTURING METHOD THEREOF AND DISPLAY DEVICE

(71) Applicant: BOE Technology Group Co., Ltd., Beijing (CN)

(72) Inventors: Yunsik Im, Beijing (CN); Yoonsung Um, Beijing (CN); Liwei Liu, Beijing (CN); Feng Liao, Beijing (CN); Hui Zhang, Beijing (CN); Yunyun Tian, Beijing (CN); Hyunsic Choi, Beijing (CN)

(73) Assignee: BOE Technology Group Co., Ltd., Beijing (CN)

(21) Appl. No.: 16/242,261

(22) Filed: Jan. 8, 2019

(30) Foreign Application Priority Data
Feb. 11, 2018 (CN) 201810141989.6

(51) Int. Cl. G02F 1/1335; G02F 1/1343; G02F 1/1362

(52) U.S. Cl. CPC G02F 1/133528; G02F 1/134309; G02F 2001/133548; G02F 2001/136222; G02F 1/136209

(57) ABSTRACT

The present disclosure provides a display panel, a manufacturing method thereof and a display device. The display panel includes: a first substrate and a second substrate arranged opposite to each other, a liquid crystal layer arranged between the first substrate and the second substrate; and a first polarizer arranged between the first substrate and the liquid crystal layer. Liquid crystal molecules in the liquid crystal layer are initially aligned without an alignment film.

### CROSS-REFERENCE TO RELATED APPLICATION

The present application claims a priority of the Chinese patent application No. 201810141989.6 filed on Feb. 11, 2018, which is incorporated herein by reference in its entirety.

### TECHNICAL FIELD

The present disclosure relates to the field of display technology, in particular to a display panel, a manufacturing method thereof and a display device.

### BACKGROUND

With development of Thin Film Transistor Liquid Crystal Display (TFT-LCD) technology as well as industrial technology, the manufacture cost of an LCD has been decreased and a manufacture process thereof has become more mature, the TFT-LCD has become a most popular technology instead of Cathode Ray Tube (CRT) display device in the field of flat panel display. In addition, the TFT-LCD has become an ideal display device for customers for its own advantages. However, display effect of the LCD may still be adversely affected by some factors. For example, when a color filter layer adopts quantum-dot material, the color filter layer is arranged under a TFT array to achieve a color display function in such a way that a light beam entering the display panel from below will be deflected to some extent, and when a deflection level is relatively large, the light beam for one subpixel may enter an adjacent subpixel, resulting in a crosstalk phenomenon and the display effect may be adversely affected. Hence, there is an urgent need for further improvement in LCD panel.

### SUMMARY

In one aspect, the present disclosure provides in some embodiments a display panel, including: a first substrate and a second substrate arranged opposite to each other; a liquid crystal layer arranged between the first substrate and the second substrate; and a first polarizer arranged between the first substrate and the liquid crystal layer. Liquid crystal molecules in the liquid crystal layer are initially aligned without an alignment film.

In a possible embodiment of the present disclosure, the liquid crystal molecules in the liquid crystal layer are initially aligned through an optical alignment process or arranged freely.

In a possible embodiment of the present disclosure, the display panel further includes: a first ultraviolet filter film arranged on a surface of the liquid crystal layer adjacent to the first substrate, wherein the first ultraviolet filter film is provided with a first alignment molecular chain on a surface adjacent to the liquid crystal layer; and a second ultraviolet filter film arranged on a surface of the liquid crystal layer adjacent to the second substrate, wherein the second ultraviolet filter film is provided with a second alignment molecular chain on a surface adjacent to the liquid crystal layer.

In a possible embodiment of the present disclosure, the liquid crystal layer contains liquid crystal nanocapsules.

In a possible embodiment of the present disclosure, each liquid crystal nanocapsule has a particle size of 100 to 200 nm.

In a possible embodiment of the present disclosure, a first electrode is arranged at a side of the first polarizer adjacent to the liquid crystal layer, and a second electrode is arranged at a side of the second substrate adjacent to the liquid crystal layer.

In a possible embodiment of the present disclosure, a third electrode, an insulation layer and a fourth electrode are sequentially arranged at a side of the second substrate adjacent to the liquid crystal layer in a direction toward the liquid crystal layer.

In a possible embodiment of the present disclosure, the first polarizer has a thickness of 100 nm to 20 nm.

In a possible embodiment of the present disclosure, the first polarizer is an attached polarizer, a coated polarizer or a wire-grid polarizer.

In a possible embodiment of the present disclosure, the display panel further includes a color filter layer arranged between the first substrate and the first polarizer. The color filter layer includes a black matrix and a plurality of color filter sheets arranged at a same layer as the black matrix, each of the color filter sheets contains a quantum-dot material. The black matrix is configured to define a plurality of subpixel openings spaced apart from each other and arranged in an array form, and each color filter sheet is arranged within a corresponding subpixel opening.

In a possible embodiment of the present disclosure, each color filter sheet includes a non-quantum-dot color filter sheet and a quantum-dot color filter sheet superimposed one on another.

In a possible embodiment of the present disclosure, the quantum-dot color filter sheet is arranged at a side of the non-quantum-dot color filter sheet adjacent to the liquid crystal layer.

In a possible embodiment of the present disclosure, the plurality of subpixel openings includes red subpixel openings, green subpixel openings and blue subpixel openings. The plurality of color filter sheets includes red color filter sheets each arranged in a corresponding red subpixel opening and green color filter sheets each arranged in a corresponding green subpixel opening. A transparent material is arranged in each blue subpixel opening.

In a possible embodiment of the present disclosure, the plurality of subpixel openings includes red subpixel openings, green subpixel openings and blue subpixel openings. The plurality of color filter sheets includes red color filter sheets each arranged in a corresponding red subpixel opening, green color filter sheets each arranged in a corresponding green subpixel opening, and blue color filter sheets each arranged in a corresponding blue subpixel opening.

In another aspect, the present disclosure provides in some embodiments a display device including the above-mentioned display panel.

In a possible embodiment of the present disclosure, a second polarizer and a blue backlight are arranged at a side of the second substrate away from the liquid crystal layer.

In a possible embodiment of the present disclosure, the display panel further includes a color filter layer arranged between the first substrate and the first polarizer. The color filter layer includes a black matrix and a plurality of color filter sheets arranged at a same layer as the black matrix, each of the color filter sheets contains a quantum-dot material. The black matrix is configured to define a plurality of subpixel openings spaced apart from each other and arranged in an array form, and each color filter sheet is arranged within a corresponding subpixel opening.

In a possible embodiment of the present disclosure, the plurality of subpixel openings includes red subpixel openings, green subpixel openings and blue subpixel openings. The plurality of color filter sheets includes red color filter sheets each arranged in a corresponding red subpixel opening and green color filter sheets each arranged in a corresponding green subpixel opening. A transparent material is arranged in each blue subpixel opening.

In yet another aspect, the present disclosure further provides in some embodiments a method for manufacturing a display panel, including: forming a first polarizer on one surface of a first substrate; and arranging the first substrate and the second substrate oppositely to form a cell. The first polarizer is arranged adjacent to the second substrate, and liquid crystal molecules in a liquid crystal layer are initially aligned without an alignment film.

In a possible embodiment of the present disclosure, subsequent to forming the first polarizer and prior to arranging the first substrate and the second substrate oppositely to form a cell, the method further includes forming a first ultraviolet filter film on a surface of the first polarizer away from the first substrate and forming a second ultraviolet filter film on a surface of the second substrate adjacent to the first substrate.

### BRIEF DESCRIPTION OF THE DRAWINGS

FIG. 1 is a schematic structural view showing a display panel according to some embodiments of the present disclosure;

FIG. 2 is another schematic structural view showing the display panel according to some embodiments of the present disclosure;

FIG. 3 is a schematic structural view showing an alignment procedure of SAVA liquid crystals according to some embodiments of the present disclosure;

FIG. 4A is yet another schematic structural view showing the display panel according to some embodiments of the present disclosure;

FIG. 4B is still another schematic structural view showing the display panel according to some embodiments of the present disclosure;

FIG. 5A is still another schematic structural view showing the display panel according to some embodiments of the present disclosure;

FIG. 5B is still another schematic structural view showing the display panel according to some embodiments of the present disclosure;

FIG. 6A is still another schematic structural view showing the display panel according to some embodiments of the present disclosure;

FIG. 6B is still another schematic structural view showing the display panel according to some embodiments of the present disclosure;

FIG. 7A is still another schematic structural view showing the display panel according to some embodiments of the present disclosure;

FIG. 7B is still another schematic structural view showing the display panel according to some embodiments of the present disclosure;

FIG. 8A is a schematic structural view showing a display device according to some embodiments of the present disclosure;

FIG. 8B is another schematic structural view showing the display device according to some embodiments of the present disclosure;

FIG. 9 is a flow chart of a method for manufacturing the display panel according to some embodiments of the present disclosure;

FIG. 10A is still another schematic structural view showing the display panel according to some embodiments of the present disclosure; and

FIG. 10B is still another schematic structural view showing the display panel according to some embodiments of the present disclosure.

### DETAILED DESCRIPTION OF THE EMBODIMENTS

The present disclosure will be described hereinafter in conjunction with the drawings and embodiments. The following embodiments are for illustrative purposes only, but shall not be used to limit the scope of the present disclosure. Where no technique or condition is specified, the known technique or condition, or that specified in a product manual, may be applied. Where no manufacturer of a reagent or instrument is specified, the market-available reagent or instrument may be applied.

In the related art, a color crosstalk phenomenon may occur during operations of a quantum-dot display panel. It is found that, the color crosstalk can be alleviated remarkably through providing a polarizer in a liquid crystal cell (i.e., providing a quantum-dot color filter layer above a liquid crystal layer and providing the polarizer at a side of the quantum-dot color filter layer adjacent to the liquid crystal layer). However, the conventional polarizer is made of a material having insufficient heat resistance (a heat-resistance temperature of an iodine-containing polarizer is not greater than 100° C., and a heat-resistance temperature of a dye-containing polarizer is not greater than 130° C.). During the formation of an alignment film (having a curing temperature of 230° C.), the polarizer may be disabled. In view of above problems, the present disclosure provides a display panel capable of initially aligning liquid crystal molecules in the liquid crystal layer without an alignment film, and arranging the polarizer inside the liquid crystal cell, thereby to effectively alleviate the color crosstalk.

The present disclosure provides in some embodiments a display panel which, as shown in FIG. 1, includes: a first substrate 100 and a second substrate 200 arranged opposite to each other; a liquid crystal layer 300 arranged between the first substrate 100 and the second substrate 200; and a first polarizer 400 arranged between the first substrate 100 and the liquid crystal layer 300. Liquid crystal molecules in the liquid crystal layer 300 are initially aligned without an alignment film. According to the embodiments of the present disclosure, the liquid crystal molecules in the liquid crystal layer can be initially aligned without an alignment film, so it is able to provide the polarizer inside a liquid crystal cell, thereby to alleviate the color crosstalk remarkably and improve the display quality.

It should be appreciated that, when the liquid crystal molecules in the liquid crystal layer are initially aligned without an alignment film, it means that the liquid crystal molecules can be arranged in a predetermined alignment direction while it is unnecessary to provide any alignment film. In a possible embodiment of the present disclosure, in order to ensure a normal display function of the display panel and prevent the first polarizer inside the liquid crystal cell from being disabled during manufacture by setting no alignment film, the liquid crystal molecules in the liquid crystal layer may be initially aligned through an optical alignment process or arranged freely (i.e., the liquid crystal molecules are not subjected to any alignment treatment, and the liquid crystal molecules are arranged in a nature state). Types of liquid crystals will not be particularly defined herein, as long as the above requirement is met. In a possible embodiment of the present disclosure, the liquid crystals containing reactive Mesogen liquid crystals and capable of optical alignment treatment may be adopted, or liquid crystal nanocapsules for which no alignment treatment is required may be adopted.

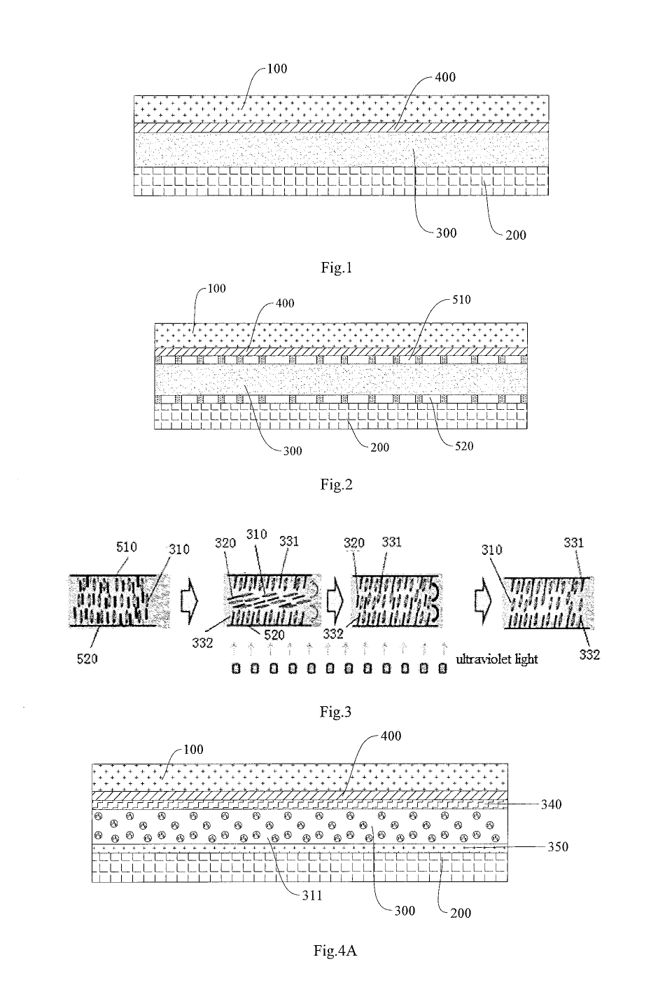

In a possible embodiment of the present disclosure, as shown in FIG. 2, the liquid crystal layer 300 includes the liquid crystals containing reactive Mesogen liquid crystals (e.g., the liquid crystals produced by MERCK and containing reactive Mesogen (RM) liquid crystals and NEGATIVE L/C). A first ultraviolet filter film 510 is arranged on a surface of the first polarizer 400 away from the first substrate 100, and a second ultraviolet filter film 520 is arranged on a surface of the second substrate 200 adjacent to the liquid crystal layer 300. When the liquid crystal layer is irradiated with an ultraviolet light beam, the reactive Mesogen liquid crystals contained in the liquid crystals may form a first alignment molecular chain 331 on a surface of the first ultraviolet filter film away from the first substrate, and form a second alignment molecular chain 332 on a surface of the second ultraviolet filter film away from the second substrate, such that the liquid crystal molecules can be aligned along the first alignment molecular chain 331 and the second alignment molecular chain 332. At this time, it is unnecessary to provide the alignment film, so it is able to prevent the first polarizer from being damaged as compared with the related art where the alignment film is cured at a high temperature, and provide the polarizer inside a liquid crystal cell, thereby to improve the display quality.

For a better understanding of the present disclosure, an optical alignment procedure of the liquid crystals containing the RM liquid crystals will be described hereinafter. As shown in FIG. 3, when the first substrate is arranged opposite to the second substrate to form a cell and the liquid crystals are injected into the cell, the liquid crystal layer 300 may be energized and subjected to ultraviolet irradiation for the first time. At this time, the RM liquid crystals 320 contained in the liquid crystal layer 300 may form the first alignment molecular chain 331 on the surface of the first ultraviolet filter film 510 adjacent to the liquid crystal layer and the second alignment molecular chain 332 on the surface of the second ultraviolet filter film 520 adjacent to the liquid crystal layer. The alignment molecular chains provide a structure similar to a channel. The liquid crystal molecules 310 may be arranged along the channel at a pretilt angle. Then, the liquid crystal layer may be subjected to the ultraviolet irradiation for the second time, so as to align the liquid crystal molecules 310 in a Vertical Alignment (VA) mode with the RM liquid crystals being eliminated. During the manufacture, the ultraviolet filter films may serve as the alignment films, and they may not be subjected to high-temperature treatment, so as to prevent the first polarizer inside the liquid crystal cell from being disabled due to high temperature, thereby to alleviate the color crosstalk. In addition, since the polarizer is provided inside the liquid crystal cell, it is able to omit subsequent steps of assembling the polarizer, thereby to simplify the manufacture.

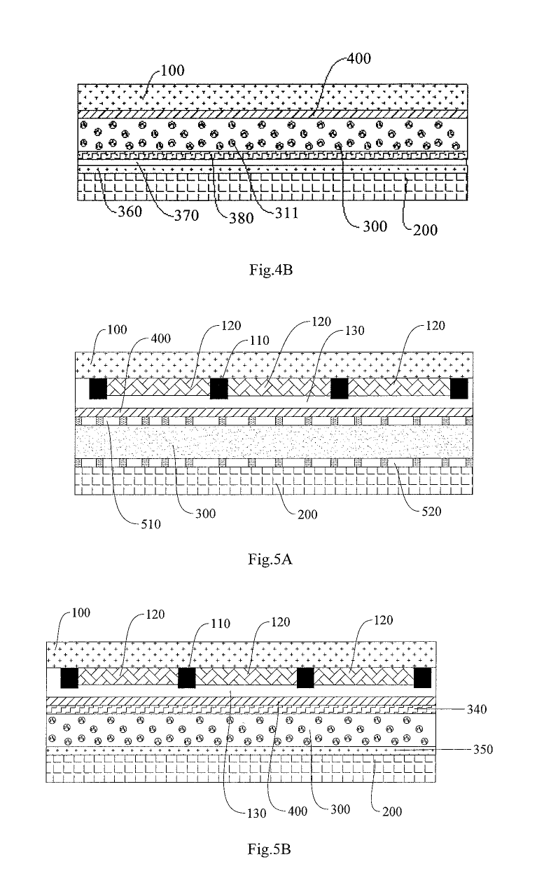

In a possible embodiment of the present disclosure, as shown in FIGS. 4A and 4B, the liquid crystal layer includes liquid crystal nanocapsules 311, and a deflection direction of each liquid crystal nanocapsule may vary along with a voltage applied thereto. In addition, it is unnecessary to subject the liquid crystal nanocapsules to high-temperature treatment. During the manufacture of the display panel, it is unnecessary to initially align the liquid crystal molecules, i.e., the liquid crystal molecules may be arranged freely in a manufactured display panel. During the display, an appropriate voltage may be applied to the liquid crystal molecules, so as to adjust the arrangement state of the liquid crystal molecules, thereby to meet the requirement of display. In this case, it is unnecessary to provide any alignment film at either side of the liquid crystal layer. As a result, it is able to provide the first polarizer inside the liquid crystal cell as well as align the liquid crystal molecules by controlling the deflection direction of the liquid crystal nanocapsules through adjusting the voltage applied to the liquid crystal layer.

In a possible embodiment of the present disclosure, each liquid crystal nanocapsule includes a wall and liquid crystals surrounded by the wall. Usually, the wall may be made of a polymer, and it may be of a single-layered or multi-layered structure. The liquid crystal nanocapsule may refer to a liquid crystal capsule having a nanoscale particle size. Types of the liquid crystal nanocapsules will not be particularly defined herein, as long as the above-mentioned technical effect may be achieved.

In a possible embodiment of the present disclosure, in order to achieve a better display effect, each liquid crystal nanocapsule may have a particle size of 100 to 200 nm. The liquid crystal nanocapsule with a relatively small particle size has relatively high optical efficiency, so it is able to effectively improve a dark state of the display panel and provide a high contrast (CR). In addition, the smaller the particle size, the better the effect.

A voltage application mode of the liquid crystal nanocapsules will not be particularly defined herein, as long as the deflection direction of the liquid crystal molecules may be adjusted effectively. In a possible embodiment of the present disclosure, as shown in FIG. 4A, a first electrode 340 and a second electrode 350 may be arranged at two sides of the liquid crystal layers 300 respectively. The first electrode 340 may be arranged at a side of the first polarizer 400 adjacent to the liquid crystal layer 300, and the second electrode 350 may be arranged at a side of the second substrate 200 adjacent to the liquid crystal layer 300.

In a possible embodiment of the present disclosure, as shown in FIG. 4B, a third electrode 360, an insulation layer 370 and a fourth electrode 380 may also be arranged at a side of the liquid crystal layer. To be specific, the third electrode 360, the insulation layer 370 and the fourth electrode 380 may be sequentially arranged at a side of the second substrate adjacent to the liquid crystal layer in a direction toward the liquid crystal layer.

Of course, the above arrangement mode of the electrodes is for illustrative purposes only, but shall not be used to limit the scope of the present disclosure. Actually, any arrangement mode of the electrodes shall fall within the scope of the present disclosure, as long as the deflection direction of the liquid crystal molecules in the liquid crystal nanocapsules may be adjusted.

Types of the first substrate and the second substrate will not be particularly defined herein. In a possible embodiment of the present disclosure, the first substrate and the second substrate may each be a metal substrate, a polymer substrate or a glass substrate which are widely available and have good performance.

In a possible embodiment of the present disclosure, a TFT array may be arranged on a surface of the second substrate adjacent to the liquid crystal layer. Types of TFTs will not be particularly defined herein and can be selected freely by those skilled in the art depending upon practical requirements.

In a possible embodiment of the present disclosure, in order to further improve the display effect and provide a thin and light product, the first polarizer may have a thickness of 100 nm to 20 μm, e.g., 500 nm, 800 nm, 1 nm, 5 μm, 10 μm or 15 μm. Through the first polarizer having the mentioned thickness, it is able to meet the requirement of display and reduce a distance between a color filter layer and the second substrate, thereby to further alleviate the color crosstalk.

Types of the first polarizer will not be particularly defined herein. In a possible embodiment of the present disclosure, the first polarizer may be an attached polarizer, a coated polarizer or a wire grid polarizer. To be specific, the attached polarizer refers to a conventional polarizer, e.g., the aforementioned iodine-containing or dye-containing polarizer, capable of being attached at a predetermined position. The coated polarizer refers to a polarizer formed by directly coating an organic material having a polarization property at a predetermined position, and types of the organic material will not be particularly defined herein. The wire grid polarizer refers to a wire grid having a grating space far less than an optical wavelength. Such parameters as a material of the wire grid polarizer and the grating space may be selected according to the practical need.

In a possible embodiment of the present disclosure, as shown in FIGS. 5A and 5B, the display panel further includes a color filter layer. The color filter layer may include a black matrix 110 and a plurality of color filter sheets 120 arranged at a same layer as the black matrix, each of the color filter sheets contains a quantum-dot material. The black matrix 110 may be configured to define a plurality of subpixel openings spaced apart from each other and arranged in an array form, and each color filter sheet 120 may be arranged within a corresponding subpixel opening.

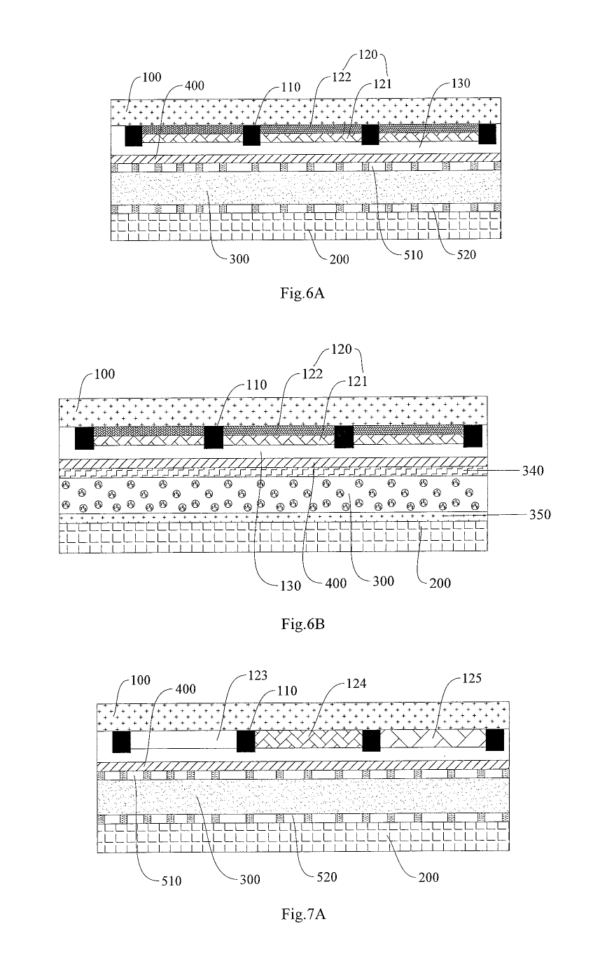

In a possible embodiment of the present disclosure, as shown in FIGS. 5A and 5B, each color filter sheet 120 may be of a single-layered structure, i.e., the quantum-dot material may be patterned so as to form the color filter sheet. In this way, it is able to allow the light beam to pass in an accurate manner, thereby to improve the color gamut of the display panel. In order to improve the display effect of the display panel, each color filter sheet may include a quantum-dot color filter sheet and a non-quantum-dot color filter sheet superimposed one on another. To be specific, as shown in FIGS. 6A and 6B, each color filter sheet 120 may include a quantum-dot color filter sheet 121 and a non-quantum-dot color filter sheet 122 superimposed one on another. The quantum-dot color filter sheet contains a quantum-dot material, which includes, but not limited to, a silicon-based quantum-dot material, a germanium-based quantum-dot material, a cadmium sulfide-based quantum-dot material, a cadmium selenide-based quantum-dot material, a cadmium telluride-based quantum-dot material, a zinc selenide-based quantum-dot material, a lead sulfide-based quantum-dot material, a lead selenide-based quantum-dot material, an indium phosphide-based quantum-dot material, or an indium arsenide-based quantum-dot material. The quantum-dot material is capable of emitting a light beam in a predetermined color under the excitation of light, so as to provide vivid colors. In addition, along with a decrease in a size of a quantum dot, its photoluminescence spectrum may be blue-shifted. The smaller the size, the more obvious the blue-shifting effect. Hence, the size of the quantum dot may be selected in accordance with a wavelength of the light beam in the predetermined color and a type of the quantum-dot material. The non-quantum-dot color filter sheet may be made of a conventional color filter material, e.g., resin, and it is capable of allowing the light beams within a desired wavelength range to pass therethrough and reflecting other undesired light beams, so it is able to further improve the color purity as well as the display effect.

In a possible embodiment of the present disclosure, as shown in FIGS. 6A and 6B, the quantum-dot color filter sheet 121 is arranged at a side of the non-quantum-dot color filter sheet 122 adjacent to the liquid crystal layer 300.

In a possible embodiment of the present disclosure, in order to achieve a color display function, the display panel may include subpixels in different colors. Correspondingly, the plurality of color filter sheets may be in different colors, e.g., the plurality of color filter sheets may include red color filter sheets, green color filter sheets and blue color filter sheets, or include red color filter sheets, green color filter sheets, blue color filter sheets and transparent sheets, or include red color filter sheets, green color filter sheets, blue color filter sheets and yellow color filter sheets. Each color filter sheet may be arranged in a subpixel opening in a same color. In addition, an arrangement mode of the color filter sheets in different colors will not be particularly defined herein. For example, the color filter sheets may be arranged in a like manner as conventional display panel, e.g., columns of the red color filter sheets, green color filter sheets and blue color filter sheets may be arranged periodically.

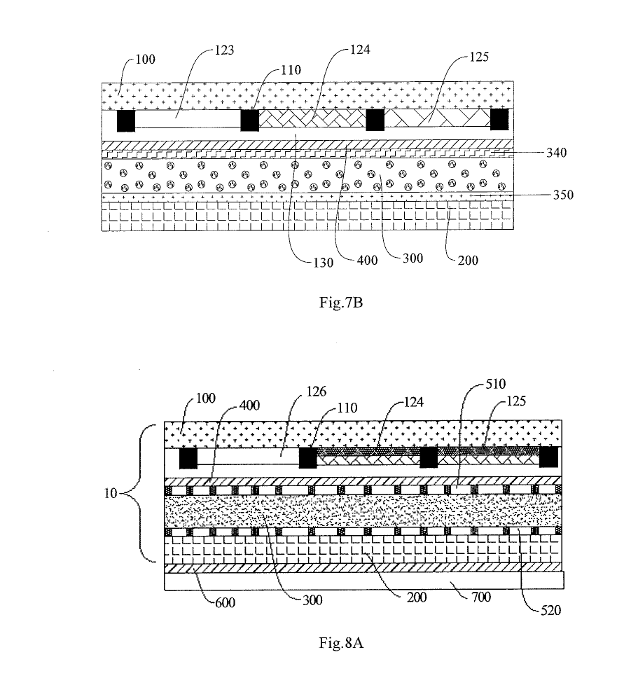

Taking a three-primary-color display panel as an example, as shown in FIGS. 7A and 7B, the subpixel openings may include red subpixel openings, green subpixel openings and blue subpixel openings. The plurality of color filter sheets may include red color filter sheets 125 each arranged in a corresponding red subpixel opening, green color filter sheets 124 each arranged in a corresponding green subpixel opening, and blue color filter sheets 125 each arranged in a corresponding blue subpixel opening.

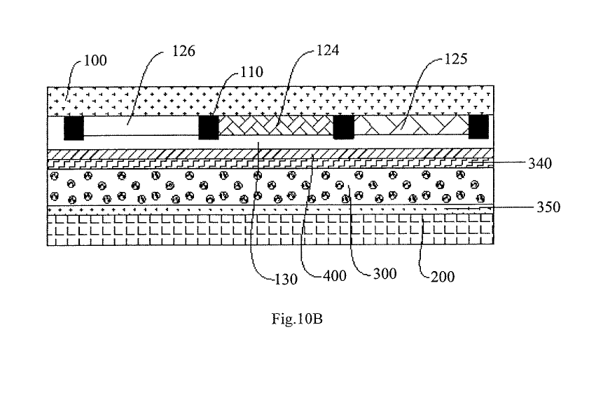

When a blue backlight is adopted, no blue color filter sheet may be arranged in each blue pixel opening. To be specific, as shown in FIGS. 10A and 10B, the subpixel openings may include the red subpixel openings, the green subpixel openings and the blue subpixel openings. The plurality of color filter sheets may include the red color filter sheets 125 each arranged in a corresponding red subpixel opening and the green color filter sheets 124 each arranged in a corresponding green subpixel opening. At this time, a transparent material 126 may be arranged in each blue subpixel opening. In this way, it is able to simplify the manufacture process, save the material and reduce the manufacture cost.

A material of the black matrix will not be particularly defined herein and can be selected freely by those skilled in the art depending upon practical requirements. In a possible embodiment of the present disclosure, the black matrix may be made of a material including, but not limited to, eriochrome black, carbon black, mixed metals, or a resin material such as a black photoresist which are widely available and have good performance. In addition, as shown in FIGS. 5A and 5B, in order to ensure a good operation performance of the display panel, an overcoat 130 may be further arranged on the surfaces of the black matrix 110 and each color filter sheet 120 away from the first substrate 100, so as to provide each of the color filter sheets and the black matrix with a flat surface, thereby to ensure a good operation performance of the display panel, facilitate the subsequent manufacture process and improve a quality of the display panel.

A material of the overcoat will not be particularly defined herein and can be selected freely by those skilled in the art depending upon practical requirements. In a possible embodiment of the present disclosure, the overcoat may be made of a passivation material, including, but not limited to, an optical adhesive (e.g., a silicone adhesive, acrylic resin, unsaturated polyester, polyurethane, or epoxy resin), or Silicon-On-Glass (SOG) which are widely available and have good performance.

The present disclosure further provides in some embodiments a display device including the above-mentioned display panel. As mentioned above, it is able to prevent the occurrence of color crosstalk for the display device, thereby to improve the quality of the display device and increase the market competitiveness thereof. The features and advantages of the display device may refer to those of the display panel, and thus will not be particularly defined herein.

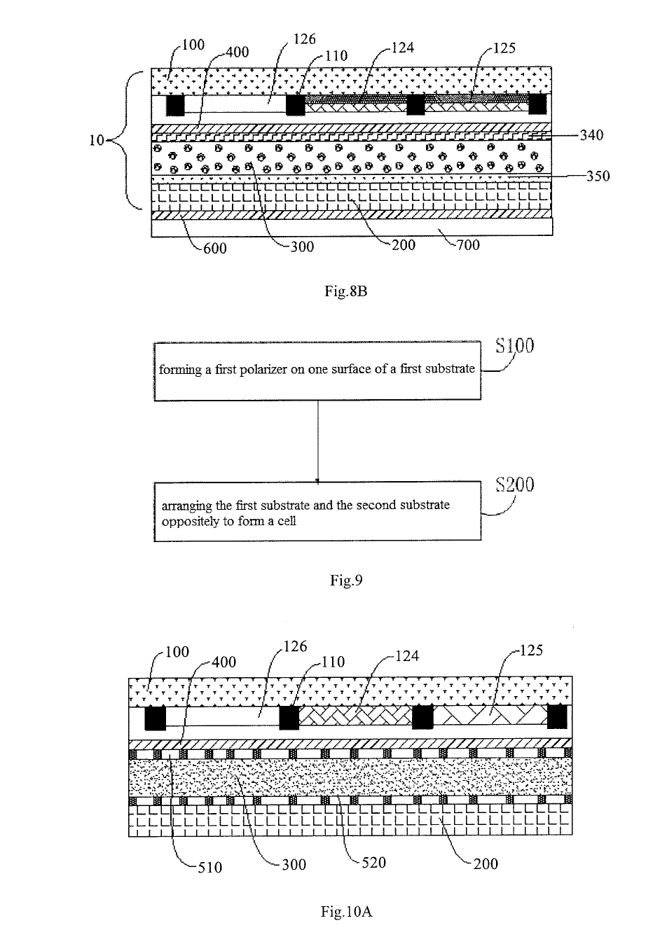

In a possible embodiment of the present disclosure, as shown in FIGS. 8A and 8B, the display device may include the above-mentioned display panel 10, a second polarizer 600 and a blue backlight 700. The second polarizer 600 and the blue backlight 700 are arranged at a side of the second substrate 200 away from the liquid crystal layer 300. The plurality of subpixel openings includes red subpixel openings, green subpixel openings and blue subpixel openings. The plurality of color filter sheets includes the red color filter sheets 125 each arranged in a corresponding red subpixel opening and the green color filter sheets 124 each arranged in a corresponding green subpixel opening. The transparent material 126 is arranged in each blue subpixel opening. In this way, it is able to achieve a display function and alleviate the color crosstalk, thereby to improve the display effect.

Types of the display device will not be particularly defined herein. To be specific, the display device may be any known device having a display function, e.g., mobile phone, flat-panel computer, computer, game machine, television, display, wearable device or any other household appliances having a display function.

Of course, it should be appreciated that, apart from the above-mentioned display panel, the display device may further include any necessary structures and members of a conventional display device. Taking the mobile phone as an example, apart from the display panel, it may further include a touch panel, a housing, a Central Processing Unit (CPU), a camera module, a fingerprint identification module, and a voice processing system, which will not be particularly defined herein.

The present disclosure further provides in some embodiments a method for manufacturing a display panel which, as shown in FIG. 9, includes the following steps.

Step S100: forming a first polarizer on one surface of a first substrate. A process for forming the first polarizer will not be particularly defined herein. In addition, a material and a thickness of the first polarizer may refer to those mentioned hereinabove, and thus will not be particularly defined.

Step S200: arranging the first substrate and the second substrate oppositely to form a cell. No alignment film is arranged on a surface of the first polarizer adjacent to a liquid crystal layer and a surface of the second substrate adjacent to the liquid crystal layer.

In the embodiments of the present disclosure, Step S200 includes forming the cell through the first substrate and the second substrate, and injecting liquid crystals between the first substrate and the second substrate. Step S200 may be implemented through any known conventional process, e.g., a spacer scattering process, a spacer fixation process, or a seal and silver paste coating process.

It is found that, the above method is simple and mature, and capable of being adopted for industrial production. In addition, it is able to prevent the occurrence of color crosstalk for the display panel manufactured by the method, thereby to improve the display effect.

The method may be adopted to manufacture the aforementioned quantum-dot display panel. The implementations of the structures and members, e.g., the array substrate, the color filter substrate, the quantum-dot color filter sheets and the first polarizer, may refer to those mentioned above, and thus will not be particularly defined herein.

In a possible embodiment of the present disclosure, subsequent to forming the first polarizer and prior to arranging the first substrate and the second substrate oppositely to form a cell, the method further includes forming a first ultraviolet filter film on a surface of the first polarizer away from the first substrate and forming a second ultraviolet filter film on a surface of the second substrate adjacent to the first substrate. In this way, it is unnecessary to perform any high-temperature treatment during the manufacture. In addition, the ultraviolet filter films may serve as the alignment films, so it is able to provide the first polarizer inside the liquid crystal cell, thereby to alleviate the color crosstalk.

The display panel manufactured by the method may have a same structure as that mentioned above. The structures of the first substrate, the second substrate, the first polarizer, the liquid crystal layer, the second polarizer, the color filter layer, the black matrix and the ultraviolet filter films may refer to those mentioned above, and any known processes may be adopted for the formation of these members.

It should be appreciated that, such words as “central”, “longitudinal”, “lateral”, “length”, “width”, “thickness”, “on”, “under”, “front”, “rear”, “left”, “right”, “vertical”, “horizontal”, “top”, “bottom”, “inside”, “outside”, “clockwise”, “counterclockwise”, “radial”, “axial” and “circumferential” are used to indicate directions or positions as viewed in the drawings, and they are merely used to facilitate the description in the present disclosure, rather than to indicate or imply that a device or member must be arranged or operated at a specific position.

In addition, such words as “first” and “second” are merely used to differentiate different components rather than to represent any order, number or importance, i.e., they are used to implicitly or explicitly indicate that there is at least one component. Further, such a phrase as “a plurality of” is used to indicate that there are at least two, e.g., two or three, components, unless otherwise specified.

Unless otherwise specified, such words as “arrange” and “connect” may have a general meaning, e.g., the word “connect” may refer to fixed connection, removable connection or integral connection, or mechanical or electrical connection, or direct connection or indirect connection via an intermediate component, or communication between two components, or wired or wireless communication connection. The meanings of these words may be understood by a person skilled in the art in accordance with the practical need.

Unless otherwise defined, when a first feature is arranged on or under a second feature, it means that the first feature is in direct contact with the second feature, or in contact with the second feature via an intermediate component. In addition, when the first feature is arranged above the second feature, it means that the first feature is arranged right above or angularly above the second feature, or the first feature is at a level higher than the second feature. When the first feature is arranged below the second feature, it means that the first feature is arranged right below or angularly below the second feature, or the first feature is at a level lower than the second feature.

Such phrases as “one embodiment”, “embodiments”, “examples” and “for example” intend to indicate that the features, structures or materials are contained in at least one embodiment or example of the present disclosure, rather than referring to an identical embodiment or example. In addition, the features, structures or materials may be combined in any embodiment or embodiments in an appropriate manner. In the case of no conflict, the embodiments or examples or the features therein may be combined in any form.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A display panel, comprising:
a first substrate and a second substrate arranged opposite to each other;
a liquid crystal layer arranged between the first substrate and the second substrate; and
a first polarizer arranged between the first substrate and the liquid crystal layer,
wherein liquid crystal molecules in the liquid crystal layer are initially aligned without an alignment film.

2. The display panel according to claim 1, wherein the liquid crystal molecules in the liquid crystal layer are initially aligned through an optical alignment process or arranged freely.

3. The display panel according to claim 1, further comprising:
a first ultraviolet filter film arranged on a surface of the liquid crystal layer adjacent to the first substrate, wherein the first ultraviolet filter film is provided with a first alignment molecular chain on a surface adjacent to the liquid crystal layer; and
a second ultraviolet filter film arranged on a surface of the liquid crystal layer adjacent to the second substrate, wherein the second ultraviolet filter film is provided with a second alignment molecular chain on a surface adjacent to the liquid crystal layer.

4. The display panel according to claim 1, wherein the liquid crystal layer contains liquid crystal nanocapsules.

5. The display panel according to claim 4, wherein each liquid crystal nanocapsule has a particle size of 100 to 200 nm.

6. The display panel according to claim 4, wherein a first electrode is arranged at a side of the first polarizer adjacent to the liquid crystal layer, and a second electrode is arranged at a side of the second substrate adjacent to the liquid crystal layer.

7. The display panel according to claim 4, wherein a third electrode, an insulation layer and a fourth electrode are sequentially arranged at a side of the second substrate adjacent to the liquid crystal layer in a direction toward the liquid crystal layer.

8. The display panel according to claim 1, wherein the first polarizer has a thickness of 100 nm to 20 μm.

9. The display panel according to claim 8, wherein the first polarizer is an attached polarizer, a coated polarizer or a wire-grid polarizer.

10. The display panel according to claim 1, further comprising a color filter layer arranged between the first substrate and the first polarizer, wherein the color filter layer comprises a black matrix and a plurality of color filter sheets arranged at a same layer as the black matrix, each of the color filter sheets contains a quantum-dot material, the black matrix is configured to define a plurality of subpixel openings spaced apart from each other and arranged in an array form, and each color filter sheet is arranged within a corresponding subpixel opening.

11. The display panel according to claim 10, wherein each color filter sheet comprises a non-quantum-dot color filter sheet and a quantum-dot color filter sheet superimposed one on another.

12. The display panel according to claim 11, wherein the quantum-dot color filter sheet is arranged at a side of the non-quantum-dot color filter sheet adjacent to the liquid crystal layer.

13. The display panel according to claim 10, wherein the plurality of subpixel openings comprises red subpixel openings, green subpixel openings and blue subpixel openings, the plurality of color filter sheets comprises red color filter sheets each arranged in a corresponding red subpixel opening and green color filter sheets each arranged in a corresponding green subpixel opening, and a transparent material is arranged in each blue subpixel opening.

14. The display panel according to claim 10, wherein the plurality of subpixel openings comprises red subpixel openings, green subpixel openings and blue subpixel openings, and the plurality of color filter sheets comprises red color filter sheets each arranged in a corresponding red subpixel opening, green color filter sheets each arranged in a corresponding green subpixel opening, and blue color filter sheets each arranged in a corresponding blue subpixel opening.

15. A display device comprising the display panel according to claim 1.

16. The display device according to claim 15, wherein a second polarizer and a blue backlight are arranged at a side of the second substrate away from the liquid crystal layer.

17. The display device according to claim 16, wherein the display panel further comprises a color filter layer arranged between the first substrate and the first polarizer, the color filter layer comprises a black matrix and a plurality of color filter sheets arranged at a same layer as the black matrix, each of the color filter sheets contains a quantum-dot material, the black matrix is configured to define a plurality of subpixel openings spaced apart from each other and arranged in an array form, and each color filter sheet is arranged within a corresponding subpixel opening.

18. The display device according to claim 17, wherein the plurality of subpixel openings comprises red subpixel openings, green subpixel openings and blue subpixel openings, the plurality of color filter sheets comprises red color filter sheets each arranged in a corresponding red subpixel opening and green color filter sheets each arranged in a corresponding green subpixel opening, and a transparent material is arranged in each blue subpixel opening.

19. A method for manufacturing a display panel, comprising: forming a first polarizer on one surface of a first substrate; and arranging the first substrate and the second substrate oppositely to form a cell, wherein the first polarizer is arranged adjacent to the second substrate, and liquid crystal molecules in a liquid crystal layer are initially aligned without an alignment film.

20. The method according to claim 19, wherein subsequent to forming the first polarizer and prior to arranging the first substrate and the second substrate oppositely to form a cell, the method further comprises forming a first ultraviolet filter film on a surface of the first polarizer away from the first substrate and forming a second ultraviolet filter film on a surface of the second substrate adjacent to the first substrate.
